(19) United States
(12) Patent Application Publication
(10) Pub. No.: US 2012/0128461 A1
(43) Pub. Date: May 24, 2012

(54) STACKING DEVICE FOR GROUPS OF DISPOSABLE WIPES

(75) Inventor: Fabio Zampollo, Crema (CR) (IT)

(73) Assignee: TEKNOWEB SRL, Palazzo Pignano CR (IT)

(21) Appl. No.: 13/388,170

(22) PCT Filed: Aug. 4, 2010
(86) PCT No.: PCT/IT2010/000355

§ 371 Date: Jan. 31, 2012

(30) Foreign Application Priority Data
Aug. 5, 2009 (IT) CR2009A000033

(51) Int. Cl. B65B 35/50; B65G 57/03

(52) U.S. Cl. 414/788.9

(57) ABSTRACT

A stacking device suitable to pack multi-layer packets composed of a specific number of groups of disposable wipes includes:
a tamper provided with an alternating vertical translation movement;
a supporting surface of the groups having two guides separated by an empty space of lesser width than that of the groups, inside which the groups pass under the thrust of the tamper;
at least a belt to drive and convey the groups;
a lowerator member for receiving the groups stacked in packets, to transfer them to a secondary collection belt for conveying the packets to a packaging line, wherein each guide includes a fixed part and a moving part, each moving part being connected to elements suitable to generate an alternating horizontal translation movement, synchronized with the alternating vertical translation movement of the tamper, so as to increase the empty space during passage of the groups.

The invention relates to the sector of production and packaging lines of multi-layer packets of disposable wipes, wet or not.

In more detail, the invention relates to a stacking device for counting groups (or clips) of wipes, to form multi-layer packets (or stackers) composed of a predetermined number of disposable wipes.

According to prior art, lines for production and packaging of disposable wipes in multi-layer packets substantially comprise an initial zone of unwinding rolls of paper to form a multi-layer ribbon (or sausage) obtained from superimposing several strips of paper; an intermediate zone for cutting the sausage so as to produce groups of wipes folded on top of one another; a zone for counting and ejecting the stacks to form multi-layer packets composed of a predetermined number of clips of wipes and a final zone for packaging said packets.

All the handling and synchronization operations are managed by specific electronic control boards of the electromechanical members.

Currently, the groups of wipes are conveyed, on a main line, in the passage from the cutting step to the counting and ejecting step, on a surface composed of two mutually parallel guides, spaced apart by a space slightly narrower than the width of the groups. The distance between the guides is adjustable, during operations to set the machine, on the basis of the width of these groups. The guides are then maintained at a fixed distance during the processing and production steps. The groups are fed along the path by belts provided with pushing fingers.

Stacking devices of known type, suitable to count and superimpose groups of wipes to form packets, generally comprise tamper means suitable to push the groups of wipes folded one on top of another downward to transfer them from the guides of the main production line to secondary ejection lines, parallel to the main line, and which can be eventually translated laterally with respect thereto.

Conventionally, said tampers are of the type provided with a vertically moving connecting rod and crank system, or a vertical movement system controlled by a linear motor, or composed of a pneumatic cylinder with vertical stem.

This system for managing and conveying the groups of wipes, at the service of said stacking devices, have some limits or drawbacks, particularly evident in production lines that tend to be increasingly fast.

The tampers, descending from above, oblige the single groups to deform to pass through the empty space between the two guides, necessarily narrower than the group itself.

If the two guides are positioned at a minimum mutual distance from one another and the empty space is narrow and much smaller than the width of the groups of wipes, these latter are supported well, but are subjected to considerable deformation during passage between the guides, bending according to a curve arranged with the concavity facing upward. Moreover, the tamper must impart on the groups a high downward thrust force to overcome the resistance of the guides, increasing deformation with a damaging “banana” effect, compromising correct superimposing of several packets on one another, and adding the risk of forming unsightly folds on the wipes in the contact points with the tamper.

If the two guides are positioned at a greater mutual distance and the empty space is wider and comparable to the width of the groups of wipes, these latter risk falling from the main line onto the secondary line, even without the thrust action of the tamper, and before they have reached the counting and ejection section. Disadvantageously, synchronization of all the components of the machine in phase is jeopardized, the groups of wipes fall onto the secondary line without being accompanied by the tamper and therefore in an irregular manner, compromising correct stacking thereof with other groups to form neat packets and causing undesirable halts in production.

Moreover, the higher the groups of wipes are, the greater the force that the tamper must impart to make them descend onto the secondary line, and the greater the deformation sustained by these groups is.

Disadvantageously, when the format of the groups of wipes changes it is necessary to change the distance between the guides, while when the height of the groups of wipes changes it is necessary to vary the thrust force of the tamper, always performing new setting operations on the machine, with loss of time and slowing production.

Moreover, currently in order to impart the downward thrust force exactly coincident with the two parallel guides, the tamper must have the shape of an upside-down U, which disadvantageously accentuates deformation of the groups of wipes, increasing the banana effect.

The invention aims to overcome these limits, producing a stacker unit suitable to package multi-layer packets composed of a predetermined number of groups of disposable wipes which:
does not deform and does not upset the groups of wipes during the descent step from the main to the secondary line; makes it possible to vary the shape of the tamper;
makes continuous dosing, by operators, of the thrust force imparted by the tamper as a function of the height or of the format of the groups of wipes unnecessary;
is efficient, precise and speeds up production.
   These aims are achieved with a stacking device suitable to pack multi-layer packets composed of a specific number of groups of disposable wipes, comprising:
a tamper for said groups provided with an alternating vertical translation movement;
a supporting surface of said groups comprising two guides separated by an empty space of lesser width than the width of the groups, inside which said groups pass under the thrust of the tamper;
at least a belt to drive and convey said groups;
a lowerator member, suitable to receive the groups stacked in packets, to transfer them to a secondary collection belt suitable to convey said packets to a packaging line,
   characterized in that said two guides each comprise a fixed part and a moving part, wherein each said moving part is connected to means suitable to generate an alternating horizontal translation movement, synchronized with the alternating vertical translation movement of the tamper, so as to increase the empty space separating said two guides during the passage of said groups.

According to a preferred aspect of the invention said moving part of said guides extends substantially for the work area of the tamper.

According to a further aspect of the invention, said means suitable to generate the alternating horizontal translation movement of said moving part comprise a first class lever, fixed rotatingly in a fulcrum, a first end of which cooperates with a driving cam, and a second end of which operates said moving portion by means of a carriage associated with said moving portion.

According to further preferred aspects of the invention, said stacking device comprises means for initial adjustment of the empty space between said guides, advantageously of the adjusting type, produced through screw/lead screw and which can be operated with a calibration knob.

The invention presents numerous advantages:
the groups of wipes are not subjected to any type of deformation during passage from the main line to the secondary line, as the two parallel guides with moving portions no longer offer any resistance to the passage of said groups of wipes;
in the same manner, the groups of wipes do not risk falling in advance onto the secondary line, becoming upset through free descent without being accompanied by the tamper, as the space between the guides can appropriately be lesser than the width of the wipes;
several groups can be associated to form packets of different formats with greater control of the shape of the stack obtained and without the risk of the wipes becoming upset and creating problems of the stack overturning during the ejection and packaging steps;
it is not necessary to change the thrust force of the tamper when the height of the group of wipes is changed, with considerable saving of time;
it is no longer necessary to use tampers in the shape of an upside-down U, which concentrate their forces coinciding with the two guides, with the risk of damaging the wipes, but tampers with a wide range of shapes and dimensions can be chosen, also advantageously flat and suitable to impart a more homogenous and evenly distributed downward thrust force.

The advantages of the invention will be made clearer below with the description of a preferred embodiment, provided as a non-limiting example, and with the aid of appended drawings wherein:

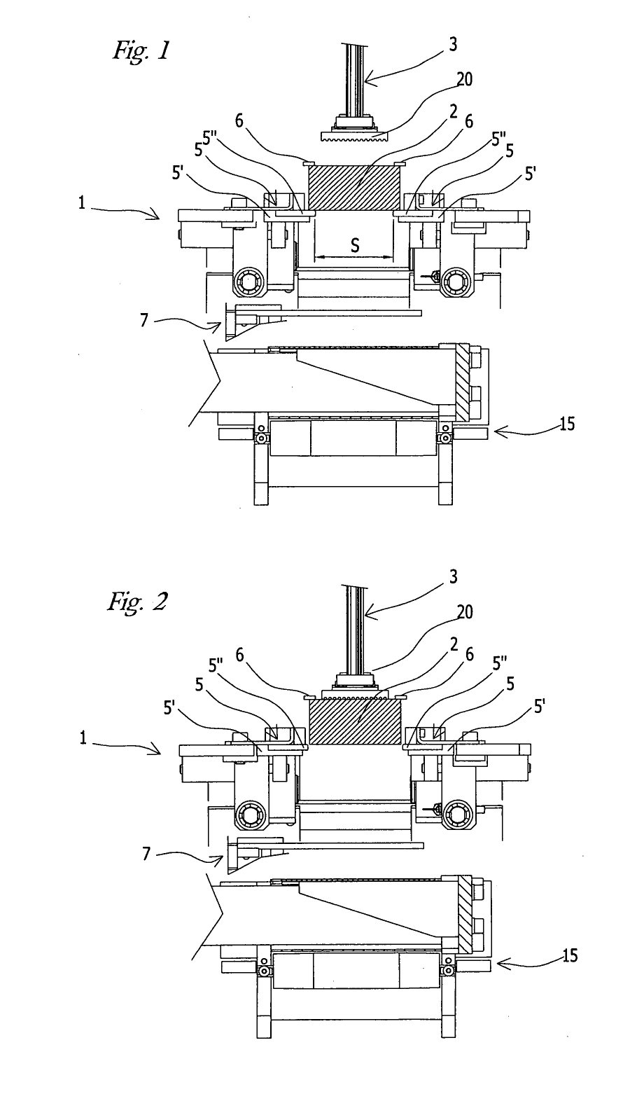

FIGS. 1 and 2 show, in schematic cross section, a stacker device according to the invention, respectively with the groups of wipes in the conveying step and in the descent step, with tamper raised and lowered.

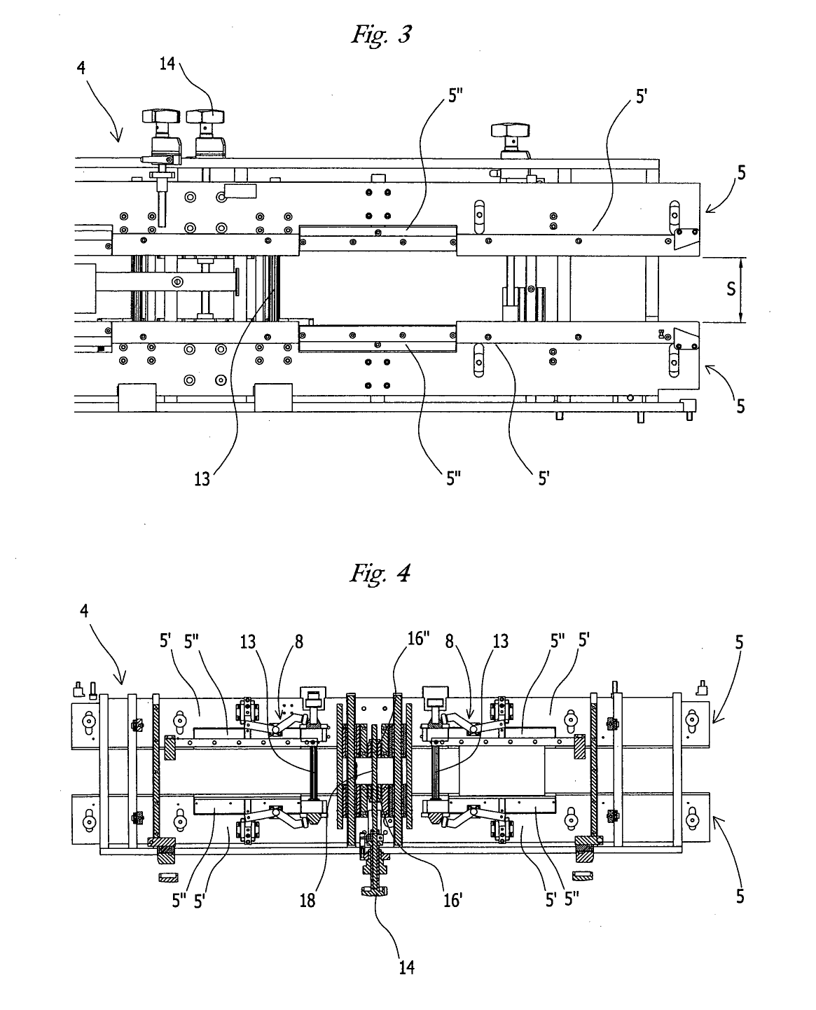

FIG. 3 represents, in a top view, the supporting surface of the stacker device according to the invention;

FIG. 4 represents, in a bottom view and partial horizontal section, the supporting surface of FIG. 3;

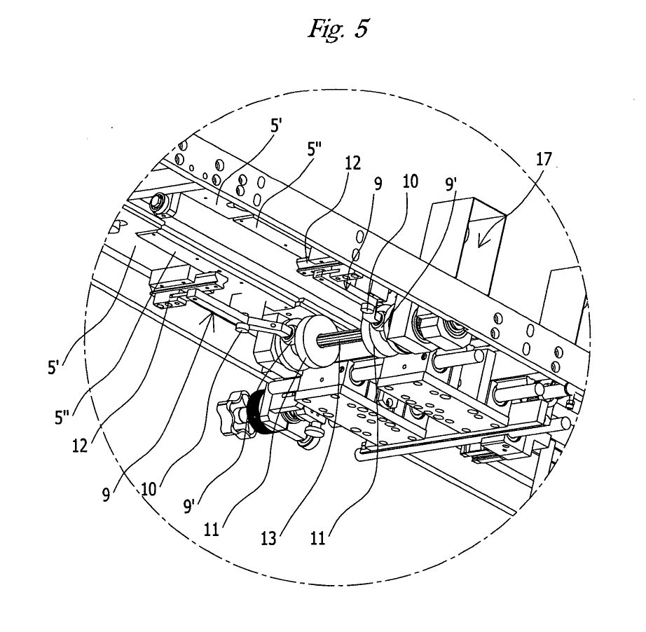

FIG. 5 represents, in a bottom perspective view, a detail of the kinematic mechanisms of the invention.

With reference to the figures, there is shown a stacking device 1 suitable to handle and count groups 2 of disposable wipes to produce multi-layer packets composed of a specific number of groups 2.

Said stacking device 1 comprises a tamper 3 for said groups 2 provided with an alternating vertical translation movement; a supporting surface 4 of said groups 2; belts 6 to drive and convey said groups 2 and a lowerator member 7 suitable to receive the groups 2 while the stack composed of a plurality of groups (or clips) is being formed and to transfer the complete stack onto a secondary belt 15 to convey them to the subsequent processing steps.

Said tamper 3 comprises a thrust member 20 substantially flat in shape, with grooved or smooth supporting surfaces.

Said supporting surface 4 comprises two guides 5 separated by an empty space S of initial width which can be set during the step to set up the machine.

Said two guides 5 each comprise a fixed part 5′ and at least one moving part 5″, wherein said moving part 5″ is arranged corresponding with the tamper 3 and has a limited length, extending substantially only for the length of the work area of the tamper 3 itself.

Each moving part 5″ is connected to means 8 suitable to generate an alternating horizontal translation movement, synchronized with the alternating vertical translation movement of the tamper 3, so as to increase the empty space S and facilitate passage of the groups 2 of wipes in the empty space S between the two guides 5 of the supporting surface 4.

In particular, FIGS. 1 and 2 respectively show the step in which the moving parts 5″ of the two guides 5 are in the two end points that make the empty space S minimum or maximum.

With reference to FIGS. 3, 4 and 5, said means 8 each comprise a first class lever 9, rotatingly fixed in a fulcrum 10.

A first end of said lever 9 comprises a bearing 9′ which cooperates with a driving cam 11, and a second end comprises a connecting rod 9″ which operates said moving portion 5″ by means of a carriage 12 associated with the same moving portion 5″.

The two driving cams 11 are fitted on a grooved bar 13, made to rotate by motor means 17.

The stacking device 1 further comprises means for initial adjustment of the empty space S between said guides 5.

Said adjustment means substantially comprise an adjusting screw 18 with opposed pitch, which can be operated with a knob 14, arranged transverse with respect to said supporting surface 4, which cooperates with two lead screws 16′ and 16″, associated with the fixed parts 5′ of said guides 5.

Operation of the System is as Follows.

A ribbon-shaped product, obtained by superimposing various strips of paper, advances along a main processing direction conveyed by a feed conveying belt until it reaches a cutting area in which it is cut into small portions, composed of groups 2 of disposable wipes.

Said groups 2 then advance, by means of belts driving device 6, to a counting and ejection area, in which at least one stacking device 1 is located, translating on a supporting surface 4 consisting of two parallel guides 5 mutually spaced apart by an empty space S.

At said at least one stacking device 1, a tamper 3 imparts, on said groups 2, a downward thrust force, in such a manner as to move the groups 2 of wipes folded one on top of another downward to transfer them from a main production line to secondary ejection lines 15.

Each moving part 5″ of the guides 5 is provided with alternating horizontal translation movement to modify the width of the empty space S promoting passage of the groups 2 of wipes and descent thereof toward the ejection belt 15.

During initial calibration of the machine, the distance between the two guides 5 is maintained lower than the width of the groups 2 of wipes, by means of an adjustment unit operated through a knob 14.

When the wipes are arranged to correspond with the tamper 3, the moving parts 5″ move away from each other, as a result of the movement of the ends of the levers 9 connected thereto, in such a manner as to increase the space S and facilitate passage of the groups 2 between the guides 5.

The groups 2 of wipes, transferred to secondary ejection lines 15, then proceed toward a final packaging area.

As will be apparent to those skilled in the art, the invention has been described with reference by way of example to a single counting and ejection area for machines to produce disposable wipes, but may be applied more in general to machines with a plurality of counting areas, and suitable for packaging any product obtained with in-line processing and with the use of a stacking device, always achieving the advantages described above.

1. A stacking device (1) suitable to pack multi-layer packets composed of a specific number of groups (2) of disposable wipes, comprising:
a tamper (3) for said groups (2) provided with an alternating vertical translation movement;
a supporting surface (4) of said groups (2) comprising two guides (5) separated by an empty space (S) of lesser width than the width of the groups (2), inside which said groups pass under the thrust of the tamper (3);
at least a belt (6) to drive and convey said groups (2);
a lowerator member (7), suitable to receive the groups (2) stacked in packets, to transfer them to a secondary collection belt (15) suitable to convey said packets to a packaging line,
characterized in that said two guides (5) each comprise a fixed part (5′) and a moving part (5″), wherein each said moving part (5″) is connected to means (8) suitable to generate an alternating horizontal translation movement, synchronized with the alternating vertical translation movement of the tamper (3), so as to increase the empty space (S) separating said two guides (5) during the passage of said groups (2).

2. A stacking device (1) according to claim 1, characterized in that the moving part (5″) of said guides (5) extends substantially for the work area of the tamper (3).

3. A stacking device (1) according to claim 1, characterized in that said means (8) comprise a first class lever (9), rotatingly fixed in a fulcrum (10), a first end (9′) of which cooperates with a driving cam (11), and a second end (9″) of which operates said moving portion (5″) by means of a carriage (12) associated with said moving portion (5″).

4. A stacking device (1) according to claim 3, characterized in that it comprises a grooved bar (13) suitable to rotate each driving cam (11).

5. A stacking device (1) according to claim 1, characterized in that it comprises means (14, 18, 16′, 16″) for initial adjustment of the empty space (S) between said guides (5).

6. A stacking device (1) according to claim 5, characterized in that said adjustment means comprise a screw (18) operated by a knob (14) and lead screws (16′, 16″) associated with the two guides (5).

7. A machine for in-line production and packaging of multi-layer packets of disposable wipes, characterized in that it comprises at least a stacking device (1) according to claim 1.
